(19) United States
(12) Patent Application Publication
(10) Pub. No.: US 2009/0251396 A1
(43) Pub. Date: Oct. 8, 2009

(54) Driving Method and Related Device for Reducing Power Noise for an LCD Device

(76) Inventor: Chin-Hung Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/185,112

(22) Filed: Aug. 3, 2008

(30) Foreign Application Priority Data
Apr. 3, 2008 (TW) 097112180

(51) Int. Cl. G09G 3/36

(52) U.S. Cl. 345/87

(57) ABSTRACT

A driving method for reducing power noise for an LCD device includes receiving a plurality of source channel output signals corresponding to a scan line of a first frame, and outputting the plurality of source channel output signals at a plurality of times, for driving the LCD device to display the scan line, wherein at least two source channel output signals are outputted at the same time in at least one of the plurality of times.

### BACKGROUND OF THE INVENTION

1. Field of the Invention

The present invention relates to a driving method and related device for reducing power noise for an LCD device, and more particularly, to a driving method and related device for outputting a plurality of source channel output signals at a plurality of times, for reducing power noise for the LCD device.

2. Description of the Prior Art

The advantages of a liquid crystal display (LCD) include lighter weight, lower power consumption, and less radiation contamination. LCD monitors have been widely applied to various portable information products, such as notebooks, mobile phones, PDAs, etc. In an LCD monitor, incident light produces different polarization or refraction effects when the alignment of liquid crystal molecules is altered. The transmission of the incident light is affected by the liquid crystal molecules, and thus magnitude of the light emitted from the liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1. FIG. 1 is a schematic diagram of a TFT LCD device 10 according to the prior art. The TFT LCD device 10 includes a panel 100, a timing controller 102, a data-line-signal output circuit 104, a scan-line-signal output circuit 106 and a voltage generator 108. The panel 100 is constructed by two parallel substrates, and the liquid crystal molecules are filled between these two substrates. A plurality of data lines 110, a plurality of scan lines 112 that are perpendicular to the data lines 110, and a plurality of TFTs 114 are positioned on one of the substrates. There is a common electrode installed on another substrate, and the voltage generator 108 is electrically connected to the common electrode for outputting a common voltage Vcom via the common electrode. Please note that only four TFTs 114 are shown in FIG. 1 for clarity. In reality, the panel 100 has one TFT 114 installed in each intersection of the data lines 110 and scan lines 112. In other words, the TFTs 114 are arranged in a matrix format on the panel 100. The data lines 110 correspond to different columns and the scan lines 112 correspond to different rows. The TFT LCD device 10 uses a specific column and a specific row to locate the associated TFT 114 that corresponds to a pixel. In addition, the two parallel substrates of the panel 100 filled up with liquid crystal molecules can be considered as an equivalent capacitor 116. In addition, the data-line-signal output circuit 104 includes a plurality of source drivers. The scan-line-signal output circuit 106 includes a plurality of gate drivers. A source driver 140 (or a gate driver 160) can drive plenty of TFTs 114. The number of the source drivers and gate drivers depends on the resolution of the TFT LCD device 10.

The operation of the TFT LCD device 10 is described as follows. The timing controller 102 generates a horizontal synchronization signal STH, a horizontal clock signal CPH, a vertical synchronization signal STV, a vertical clock signal CPV, a latch signal LD, a polarization control signal POL and an output enable signal OE. The vertical synchronization signal STV is a frame start-up signal. The data-line-signal output circuit 104 transfers a digital data signal DATA to an analog source channel output signal according to the horizontal synchronization signal STH and the horizontal clock signal CPH, controls output states of the source channel output signal according to the latch signal LD, and controls the polarity of the source channel output signal according to the polarization control signal POL, so as to drive a TFT 114. On the other hand, the scan-line-signal output circuit 106 generates a voltage signal according to the vertical synchronization signal STV and the vertical clock signal CPV and controls output states of the voltage signal according to the output enable signal OE, so as to control an on/off state of the TFT 114. In a word, the data-line-signal output circuit 104 and the scan-line-signal output circuit 106 control the on/off state of the TFT 114 and the voltage difference kept by the capacitor 116 so as to change the alignment of liquid crystal molecules and light transmittance, thereby the data signal DATA can be displayed on the panel 100.

In addition, the operation of the polarization control signal POL is described as follows. If the TFT LCD device 10 continuously uses a positive (or negative) voltage to drive the liquid crystal molecules, the liquid crystal molecules will not quickly change a corresponding alignment according to the applied voltages as before. Thus, the incident light will not produce accurate polarization or refraction, and the quality of images displayed on the TFT LCD device 10 deteriorates. In order to protect the liquid crystal molecules from being irregular, the TFT LCD device 10 must alternately use positive and the negative voltages to drive the liquid crystal molecules. A conventional line inversion driving mechanism or a dot inversion driving mechanism is widely used to solve the problem as above. The polarization control signal POL controls the polarity of source channel output signals, so as to control the polarity of a pixel to change to an opposite polarity as a frame changes.

As mentioned previously, the TFTs 114 are arranged in a matrix format on the panel 100. Each data line 110 corresponds to a column and each scan line 112 corresponds to a row. Please note that, the data signals DATA are outputted as a row at the same time to drive a row of TFTs 114 so as to display an image frame. Please refer to FIG. 2, which is a timing diagram of the TFT LCD device 10 according to the prior art. FIG. 2 shows timing waveforms of the horizontal synchronization signal STH, the horizontal clock signal CPH, the vertical synchronization signal STV, the vertical clock signal CPV, the latch signal LD, the polarity control signal POL, the output enable signal OE and the source channel output signals. In FIG. 2, the data-line-signal output circuit 104 is divided into an even source driver group and an odd source driver group, and the source channel output signals of each source driver group are further divided into even channel output signals and odd channel output signals. As shown in FIG. 2, the polarity of the polarization control signal POL changes as a frame changes. Therefore, the polarization control signal POL can control the polarity of pixels in a part of the panel 100 to change to an opposite polarity as a frame changes.

As shown in FIG. 2, power noises will occur when the data-line-signal output circuit 104 (all of the source drivers) outputs all channel output signals at the same time. Moreover, the power noises influence the image quality of the TFT LCD device 10 and even generate undesirable electromagnetic interference.

### SUMMARY OF THE INVENTION

It is therefore a primary objective of the claimed invention to provide a driving method and related devices thereof to reduce power noise of an LCD device.

The present invention discloses a driving method for reducing power noise for an LCD device comprising receiving a plurality of source channel output signals corresponding to a scan line of a first frame, and outputting the plurality of source channel output signals at a plurality of times, for driving the LCD device to display the scan line, wherein at least two source channel output signals are outputted at the same time in at least one of the plurality of times.

The present invention further discloses a driving method for reducing power noise for an LCD device comprising receiving a plurality of source channel output signals corresponding to each of a plurality of first scan lines of a first frame and a plurality of source channel output signals corresponding to each of a plurality of second scan lines of a second frame, outputting the plurality of source channel output signals corresponding to each first scan line of the first frame at a plurality of times and by a first output order according to a control signal, for driving the LCD device to display the first frame, and outputting the plurality of source channel output signals corresponding to each second scan line of the second frame at the plurality of times and by a second output order according to the control signal, for driving the LCD device to display the second frame, wherein the first output order is different from the second output order.

The present invention further discloses an LCD device for reducing power noise comprising a panel, a timing controller, a scan-line-signal output circuit and a data-line-signal output circuit. The timing controller is utilized for generating a control signal and a data signal. The scan-line-signal output circuit is coupled to the panel and the timing controller and is utilized for driving the panel to display a first frame and a second frame. The data-line-signal output circuit is coupled to the panel and the timing controller and is utilized for transferring the data signal to drive the panel. The data-line-signal output circuit comprises a reception unit and an output unit. The reception unit is utilized for receiving a plurality of source channel output signals corresponding to each of a plurality of first scan lines of the first frame and a plurality of source channel output signals corresponding to each of a plurality of second scan lines of the second frame. The output unit is coupled to the reception unit and is utilized for outputting the plurality of source channel output signals corresponding to each first scan line of the first frame at a plurality of times and by a first output order according to a control signal, for driving the LCD device to display the first frame, and outputting the plurality of source channel output signals corresponding to each second scan line of the second frame at the plurality of times and by a second output order according to the control signal, for driving the LCD device to display the second frame, wherein the first output order is different from the second output order.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a TFT LCD device according to the prior art.

FIG. 2 is a timing diagram of the TFT LCD device shown in FIG. 1 according to the prior art.

FIG. 3 is a flowchart of a process according to an embodiment of the present invention.

FIG. 4 is a flowchart of a process according to an embodiment of the present invention.

FIG. 5 is a timing diagram of an LCD device using the process shown in FIG. 4.

FIG. 6 and FIG. 7 are schematic diagrams of an LCD device according to embodiments of the present invention.

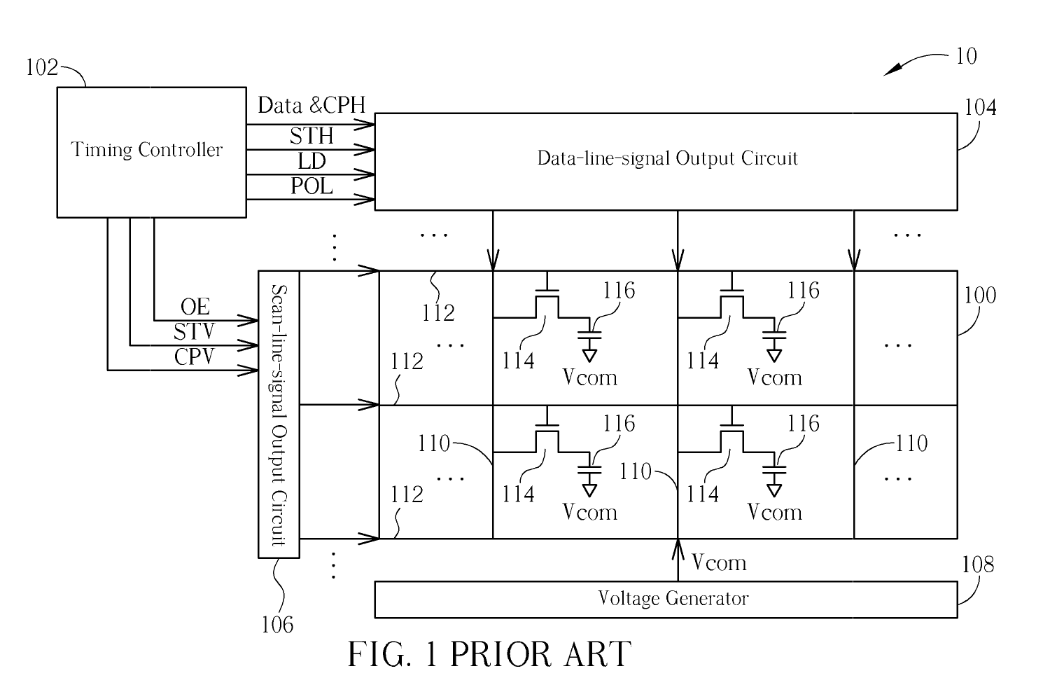

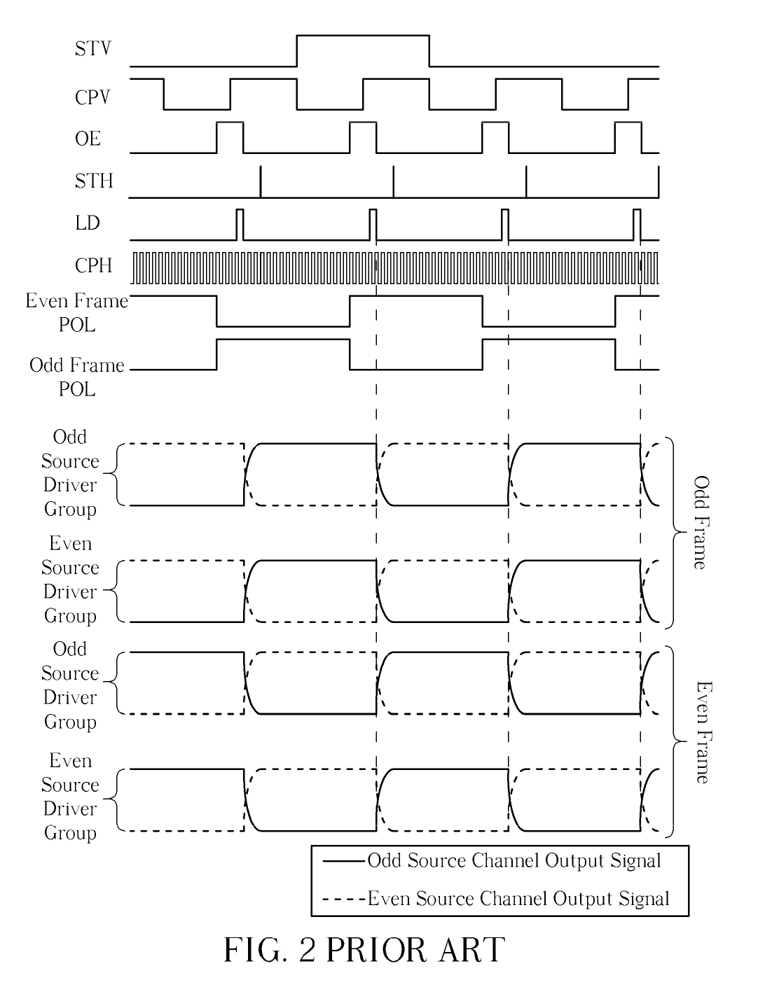

### DETAILED DESCRIPTION

As mentioned previously, in a conventional LCD device, power noises occur when all source drivers output channel output signals at the same time, so that the image quality of the LCD device deteriorates. According to the present invention, all source channel output signals are outputted at a plurality of times, and thereby the power noises are reduced.

In the following description let the number of gate channels be M and the number of source channels be N in an LCD device for clarity. The LCD device continuously displays image frames and each frame is composed of M scan lines. Each scan line corresponds to N source channel output signals outputted by a data-line-signal output circuit of the LCD device. That is, N source channel output signals can drive N source channels to display a scan line then display an image frame.

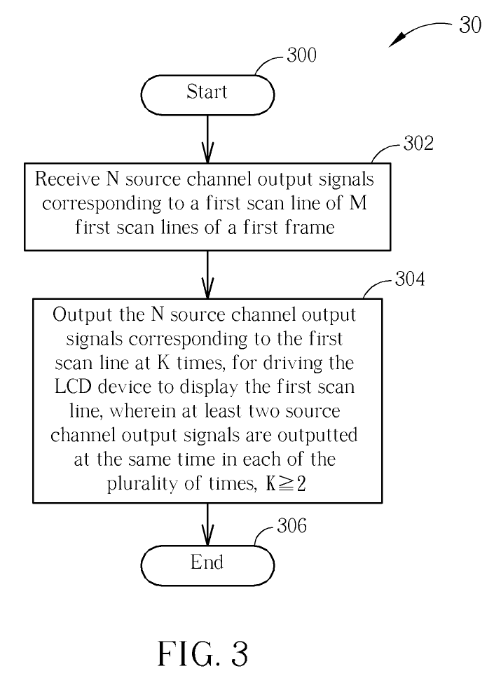

Please refer to FIG. 3, which is a flowchart of a process 30 according to an embodiment of the present invention. The process 30 includes the following steps:

Step 300: Start.

Step 302: Receive N source channel output signals corresponding to a first scan line of M first scan lines of a first frame.

Step 304: Output the N source channel output signals corresponding to the first scan line at K times, for driving the LCD device to display the first scan line, wherein at least two source channel output signals are outputted at the same time in each of the plurality of times, K≧2.

Step 306: End.

The operation of the process 30 is described as follows. Let the N source channel output signals be outputted by 6 source drivers, SD1-SD6, for example, and use a source driver as a dividing unit. Take K=2 for example, that means the N source channel output signals are divided into 2 groups and outputted at 2 different times. The source drivers SD1, SD3 and SD5 output total (N/2) source channel output signals at the same time first and then the source drivers SD2, SD4 and SD6 output total (N/2) source channel output signals at the same time, later. Please note that, the above operation helps disperse the output time of the N source channel output signals (corresponding a row of pixels), so that the N source channel output signals will not be outputted at the same time that results in power noise.

In addition, the present invention is not limited to using a source driver as a dividing unit. The present invention can also use only one source channel output signal or a plurality of source channel output signals as a dividing unit to divide the N source channel output signals. For example, the N source channel output signals can be divided into 3 (or more) groups and outputted at 3 different times. (N/3) source channel output signals are outputted at each time.

From the above, according to the process 30, the N source channel output signals corresponding to each first scan line of a first frame are outputted at K times (for example, N/K source channel output signals are outputted at each time), for driving the LCD device to display each first scan line of the first frame, so as to display the first frame.

Next, the LCD device displays a second frame after the first frame according to the process 30. The second frame is adjacent to the first frame. Similarly, N source channel output signals corresponding to each second scan line of the second frame are also outputted at K times, for driving the LCD device to display each second scan line of the second frame, so as to display the second frame. On the other hand, as a frame changes, the LCD device controls source channel output signals to transfer the polarity according to a polarization control signal generated by a timing controller, for preventing liquid crystal molecules from weariness by voltage. Therefore, the output order of the N source channel output signals corresponding to each second scan line of the second frame is identical to the output order of the N source channel output signals corresponding to each first scan line of the first frame, while the polarity of the second frame is different from the polarity of the first frame.

In other words, the LCD device displays two adjacent frames with opposite polarity by the same output order of source channel output signals. But this is only an embodiment, not a limitation of the present invention. In another embodiment of the present invention, the LCD device can also displays two adjacent frames with opposite polarity by different output order of source channel output signals.

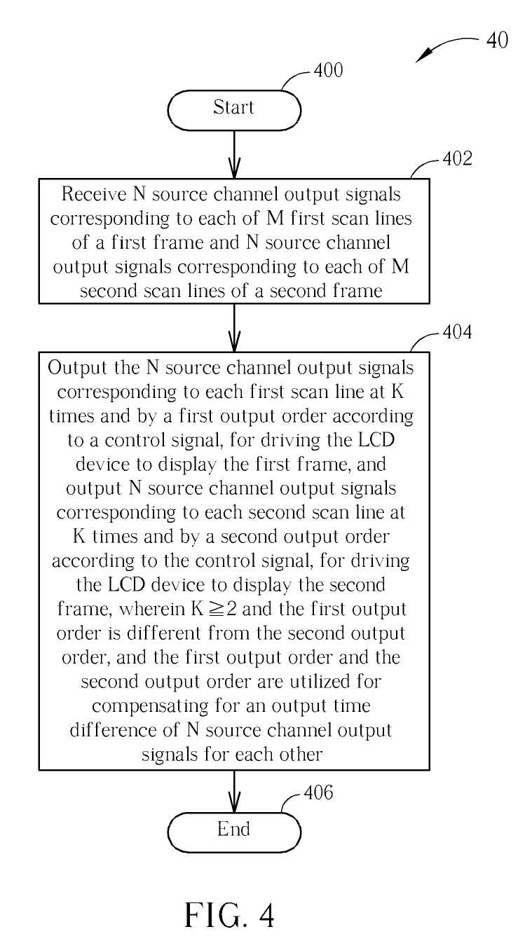

Please note that, for the reason that the N source channel output signals corresponding to each first scan line of the first frame are outputted at K times, the charging time of the equivalent capacitors will be different. To solve this problem, the output order of the N source channel output signals has to be changed after the first frame, for compensating for a charging time difference of the equivalent capacitors. Please refer to FIG. 4, which is a flowchart of a process 40 according to an embodiment of the present invention. The process 40 includes the following steps:

Step 400: Start.

Step 402: Receive N source channel output signals corresponding to each of M first scan lines of a first frame and N source channel output signals corresponding to each of M second scan lines of a second frame.

Step 404: Output the N source channel output signals corresponding to each first scan line at K times and by a first output order according to a control signal, for driving the LCD device to display the first frame, and output N source channel output signals corresponding to each second scan line at K times and by a second output order according to the control signal, for driving the LCD device to display the second frame, wherein K≧2 and the first output order is different from the second output order, and the first output order and the second output order are utilized for compensating for an output time difference of N source channel output signals for each other.

Step 406: End.

Note that, in the process 40, the first output order and the second output order are utilized for compensating for an output time difference of N source channel output signals for each other, so as to compensate for charging time difference of the equivalent capacitors. Therefore, the control signal is a frame start-up signal. In the embodiment of the present invention, the control signal can be a vertical synchronization signal. Or, the control signal can be carried by a polarization control signal. The above-mentioned control signals are two embodiment of the present invention, and those skilled in the art can make alterations and modifications accordingly.

The operation of the process 40 is described as follows. Also, let the N source channel output signals be outputted by 6 source drivers, SD1-SD6. Take K=2 for example, that means the N source channel output signals are divided into 2 groups and outputted at 2 different times; one time is by a first output order and the other time is by a second output order. First, the N source channel output signals of each first scan line of the first frame are outputted following the first output order, for displaying the first frame, and then the N source channel output signals of each second scan line of the second frame are outputted following the second output order, for displaying the second frame, later. For example, the first output order means the source drivers SD1, SD3 and SD5 output (N/2) source channel output signals first, and the source drivers SD2, SD4 and SD6 output (N/2) source channel output signals later; while the second output order means the source drivers SD2, SD4 and SD6 output (N/2) source channel output signals first, and the source drivers SD1, SD3 and SD5 output (N/2) source channel output signals later.

Note that, the first output order and the second output order are embodiments according to the present invention, and those skilled in the art can make alterations and modifications accordingly. For example, when N source channel output signals are outputted at 3 times, the output order of the N source channel output signals has to be arranged to compensate for the charging time difference.

There is no specific limitation for displaying time of the first frame or the second frame. Therefore, in the implementation of the process 40, any other frame, having the same polarity of the first frame, can be regarded as the second frame in the process 40 so as to compensate for the charging time difference. For example, the second frame can be a frame, which is two-frame next to the first frame. In this case, it can be seen that the polarity of the second frame is identical to the polarity of the first frame.

Assume that a third frame is after and adjacent to the first frame, and the polarity of the third frame is different from the polarity of the first frame, for preventing liquid crystal molecules from weariness by the same voltage. The LCD device outputs the three frames according to the above-mentioned processes 30 and 40. That is, the LCD device outputs first frame first, and then outputs the third frame according to the process 30. After the third frame, the LCD device displays the second frame according to the process 40 so as to compensate for charging time difference caused by the first frame.

In other words, the N source channel output signals corresponding to each third scan line of M third scan lines of the third frame are outputted at K times and by the first output order used in the first frame, for displaying the third frame. At the same time, the LCD device controls the N source channel output signals to transfer the polarity information according to the polarization control signal as a frame changes. Therefore, the polarity of the third frame is different from the polarity of the first frame.

Similarly, there is a fourth frame after and adjacent to the second frame. The N source channel output signals corresponding to each fourth scan line of M fourth scan lines of the fourth frame are outputted at K times and by the second output order used in the second frame, for displaying the fourth frame. The polarity of the fourth frame is different from the polarity of the second frame. From the above, when K=2, the N source channel output signals corresponding to the first frame or the third frame are outputted by the first output order, and the N source channel output signals corresponding to the second frame or the fourth frame are outputted by the second output order. The frame display sequence of the four frames is the first frame, the third frame, the second frame and the fourth frame.

In a word, in the above disclosure, the output order of the N source channel output signals of a frame is identical to that of an adjacent frame with opposite polarity. On the other hand, two frames with the same polarity are displayed according to different output orders for compensating for a charging time difference.

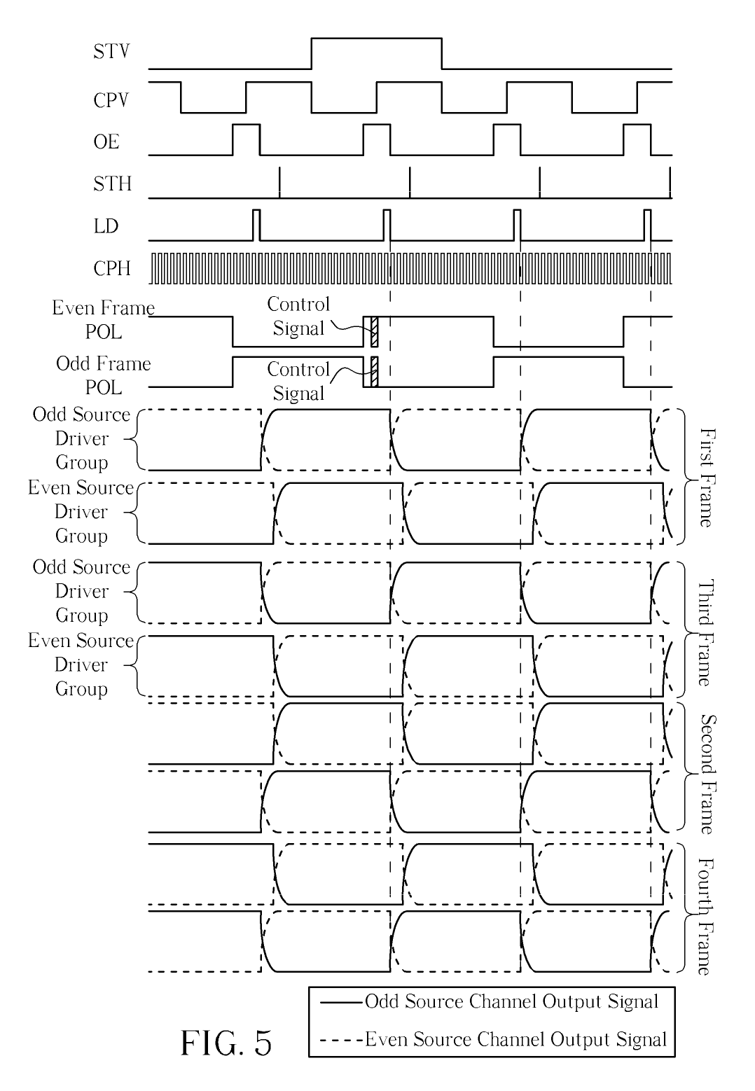

Please refer to FIG. 5, which is a timing diagram of an LCD device using the process 40. FIG. 5 shows timing waveforms of a horizontal synchronization signal STH, a horizontal clock signal CPH, a vertical synchronization signal STV, a vertical clock signal CPV, a latch signal LD, a polarization control signal POL, an output enable signal OE and source channel output signals in the first frame, the second frame, the third frame and the fourth frame, for example. In FIG. 5, the control signal is carried by the polarization control signal POL. As shown in FIG. 5, N source channel output signals are outputted at 2 different times. In other words, N source channel output signals are divided into (N/2) source channel output signals corresponding to an even source driver group and (N/2) source channel output signals corresponding to an odd source driver group. The even source driver group and the odd source driver group output source channel output signals at different times. In the first frame and the third frame, the odd source driver group outputs (N/2) source channel output signals first and the even source driver group outputs (N/2) source channel output signals later. Oppositely, in the second frame and the fourth frame, the even source driver group outputs (N/2) source channel output signals first and the odd source driver group outputs (N/2) source channel output signals later.

In FIG. 5, the LCD device uses a dot inversion driving mechanism to implement the polarization as a frame changes. And the output order of the four frames is: first frame, third frame, second frame, and fourth frame as well. Therefore, (N/2) source channel output signals of each source driver group are further divided into even source channel output signals and odd source channel output signals. Note that, FIG. 5 is an embodiment according to the present invention, and those skilled in the art can make alterations and modifications accordingly. For example, the LCD device can also use a line inversion driving mechanism to implement the polarization as a frame changes, or the control signal can be implemented by the vertical synchronization signal STV instead of being carried by the polarization control signal POL.

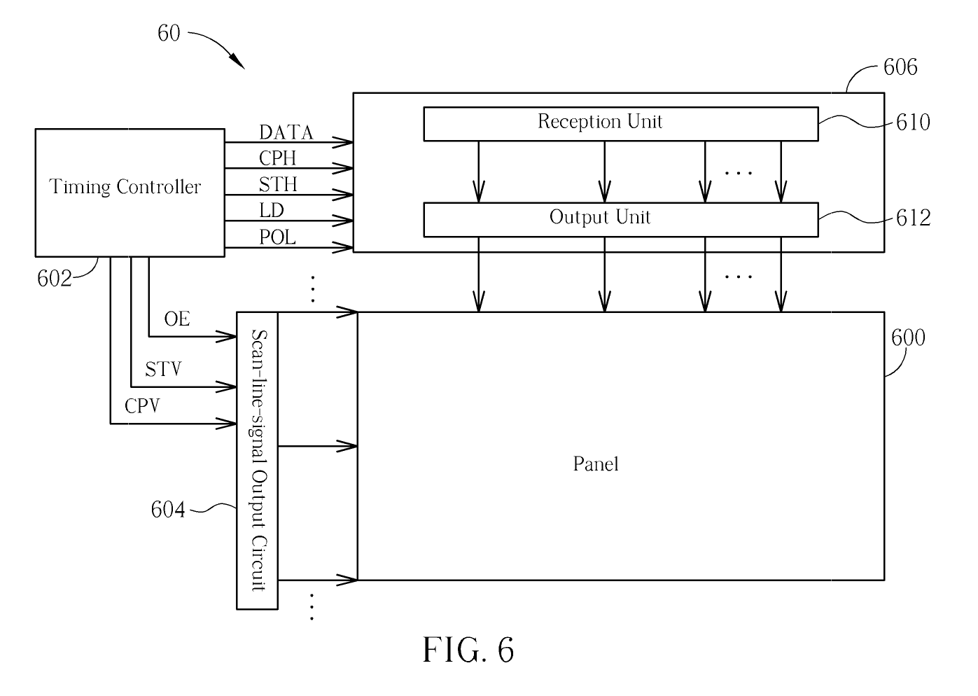

For the hardware implementation of the process 40, please refer to FIG. 6, which is a schematic diagram of an LCD device 60 according to an embodiment of the present invention. The LCD device 60 comprises a panel 600, a timing controller 602, a data-line-signal output circuit 604 and a data-line-signal output circuit 606. The timing controller 600 is utilized for generating a horizontal synchronization signal STH, a horizontal clock signal CPH, a vertical synchronization signal STV, a vertical clock signal CPV, a latch signal LD, a polarization control signal POL, an output enable signal OE, a control signal and a data signal DATA. The control signal is carried by the polarization control signal POL. The scan-line-signal output circuit 604 is coupled to the panel 600 and the timing controller 602, and is utilized for driving the panel 600 to display a plurality of frames. The data-line-signal output circuit 606 is coupled to the panel 600 and the timing controller 602, and comprises a reception unit 610 and an output unit 612. The reception unit 610 is coupled to the output unit 612. Please refer to the above-mentioned processes 30 and 40 for detailed operations of the reception unit 610 and the output unit 612. In a word, the data-line-signal output circuit 606 uses reception unit 610 and the output unit 612 to transfer the data signal DATA to source channel output signals according to the horizontal synchronization signal STH and the horizontal clock signal CPH, and controls the polarity of the source channel output signals according to the polarization control signal POL, so as to drive the panel 600. In addition, the data-line-signal output circuit 606 uses the control signal carried by the polarization control signal POL to implement the compensation for the charging time difference of the equivalent capacitors in the panel 600.

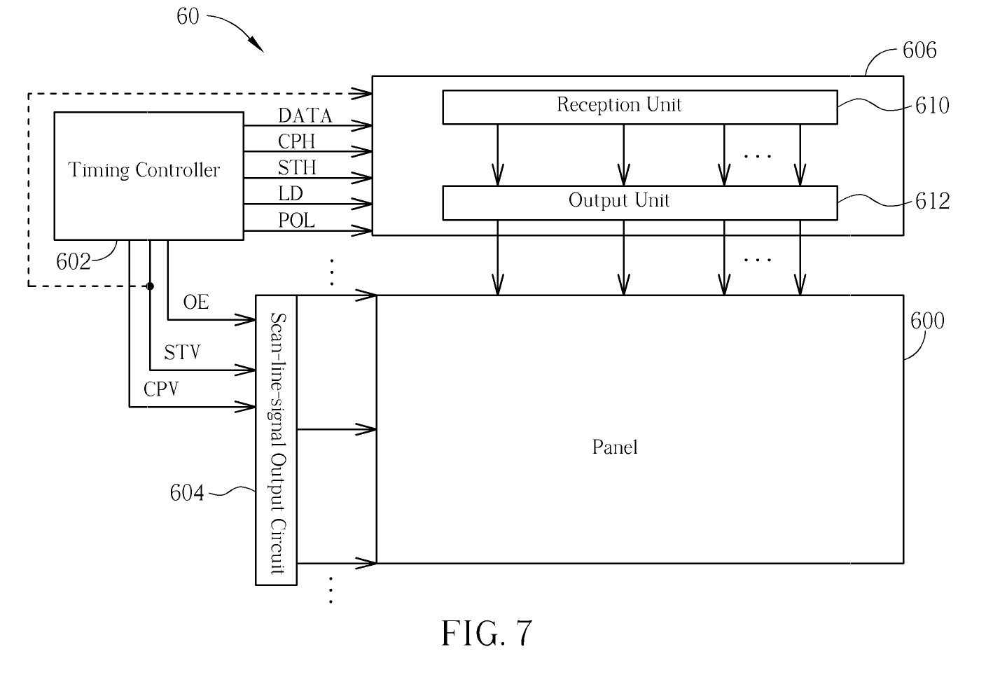

As mentioned previously, the compensation for the charging time difference is realized as a frame changes, therefore, the control signal can also be a frame start-up signal. Please refer to FIG. 7, which is also a schematic diagram of the LCD device 60 according to an embodiment of the present invention. The difference between FIG. 7 and FIG. 6 is that the control signal is carried by the polarization control signal POL in FIG. 6, while the control signal is the vertical synchronization signal STV outputted by the data-line-signal output circuit 606 in FIG. 7, presented as a dotted line. The LCD device 60 in is similar to the LCD device 60 in FIG. 6 and is not given here.

In conclusion, according to the present invention, all source channel output signals are outputted at a plurality of times. In addition, the output order of the source channel output signals changes to compensate for charging time difference of the equivalent capacitors in the panel. Therefore, the present invention reduces the power noise when source channel output signals are outputted, so as to enhance the image quality of the LCD device.

Those skilled in the art will readily observe that numerous modifications and alterations of the device and method may be made while retaining the teachings of the invention.

What is claimed is:

1. A driving method for reducing power noise for an LCD device comprising:
receiving a plurality of source channel output signals corresponding to a scan line of a first frame; and
outputting the plurality of source channel output signals at a plurality of times, for driving the LCD device to display the scan line;
wherein at least two source channel output signals are outputted at the same time in at least one of the plurality of times.

2. The driving method of claim 1 further comprising:
receiving a plurality of source channel output signals corresponding to each of a plurality of first scan lines of the first frame; and
outputting the plurality of source channel output signals corresponding to each first scan line of the first frame at the plurality of times, for driving the LCD device to display the first frame;
wherein an output order of the plurality of source channel output signals corresponding to each first scan line is identical to an output order of the plurality of source channel output signals corresponding to the scan line.

3. The driving method of claim 2 further comprising:
receiving a plurality of source channel output signals corresponding to each of a plurality of second scan lines of a second frame; and
outputting a plurality of source channel output signals corresponding to each second scan line of the second frame at the plurality of times, for driving the LCD device to display the second frame.

4. The driving method of claim 3, wherein the second frame is adjacent to the first frame; the polarity of the second frame is opposite to the polarity of the first frame; and an output order of the plurality of source channel output signals corresponding to each second scan line of the second frame is identical to the output order of the plurality of source channel output signals corresponding to each first scan line of the first frame.

5. The driving method of claim 3, wherein there is a frame between the second frame and the first frame; the polarity of the second frame is identical to the polarity of the first frame; and an output order of the plurality of source channel output signals corresponding to each second scan line of the second frame is different from the output order of the plurality of source channel output signals corresponding to each first scan line of the first frame.

6. The driving method of claim 5 further comprising:
utilizing a control signal to control output states of the plurality of source channel output signals corresponding to each second scan line of the second frame, for making the output order of the plurality of source channel output signals corresponding to each second scan line of the second frame different from the output order of the plurality of source channel output signals corresponding to each first scan line of the first frame.

7. The driving method of claim 6, wherein the control signal is a vertical synchronization signal.

8. The driving method of claim 6, wherein the control signal is carried by a polarization control signal.

9. The driving method of claim 1, wherein at least two source channel output signals are outputted at the same time in each of the plurality of times.

10. A driving method for reducing power noise for an LCD device comprising:
receiving a plurality of source channel output signals corresponding to each of a plurality of first scan lines of a first frame and a plurality of source channel output signals corresponding to each of a plurality of second scan lines of a second frame;
outputting the plurality of source channel output signals corresponding to each first scan line of the first frame at a plurality of times and by a first output order according to a control signal, for driving the LCD device to display the first frame; and
outputting the plurality of source channel output signals corresponding to each second scan line of the second frame at the plurality of times and by a second output order according to the control signal, for driving the LCD device to display the second frame;
wherein the first output order is different from the second output order.

11. The driving method of claim 10 further comprising:
receiving a plurality of source channel output signals corresponding to each of a plurality of third scan lines of a third frame and a plurality of source channel output signals corresponding to each of a plurality of fourth scan lines of a fourth frame;
outputting the plurality of source channel output signals corresponding to each third scan line of the third frame at the plurality of times and by the first output order according to the control signal, for driving the LCD device to display the third frame; and
outputting the plurality of source channel output signals corresponding to each fourth scan line of the fourth frame at the plurality of times and by the second output order according to the control signal, for driving the LCD device to display the fourth frame;
wherein the polarity of the third frame is opposite to the polarity of the first frame;
the polarity of the fourth frame is opposite to the polarity of the second frame;
and a frame display sequence is the first frame, the third frame, the second frame and the fourth frame.

12. The driving method of claim 11, wherein the control signal is a start-up signal for the first frame and the second frame.

13. The driving method of claim 12, wherein the control signal is a vertical synchronization signal.

14. The driving method of claim 11, wherein the control signal is carried by a polarization control signal.

15. An LCD device for reducing power noise comprising:
a panel;
a timing controller for generating a control signal and a data signal;
a scan-line-signal output circuit coupled to the panel and the timing controller, for driving the panel to display a first frame and a second frame; and
a data-line-signal output circuit coupled to the panel and the timing controller, for transferring the data signal to drive the panel, the data-line-signal output circuit comprising:
a reception unit for receiving a plurality of source channel output signals corresponding to each of a plurality of first scan lines of the first frame and a plurality of source channel output signals corresponding to each of a plurality of second scan lines of the second frame; and
an output unit coupled to the reception unit, for outputting the plurality of source channel output signals corresponding to each first scan line of the first frame at a plurality of times and by a first output order according to a control signal, for driving the LCD device to display the first frame, and outputting the plurality of source channel output signals corresponding to each second scan line of the second frame at the plurality of times and by a second output order according to the control signal, for driving the LCD device to display the second frame;
wherein the first output order is different from the second output order.

16. The LCD device of claim 15, wherein the reception unit further receives a plurality of source channel output signals corresponding to each of a plurality of third scan lines of a third frame and a plurality of source channel output signals corresponding to each of a plurality of fourth scan lines of a fourth frame.

17. The LCD device of claim 16, wherein the output unit further outputs the plurality of source channel output signals corresponding to each third scan line of the third frame at the plurality of times and by the first output order according to the control signal, for driving the LCD device to display the third frame, and outputting the plurality of source channel output signals corresponding to each fourth scan line of the fourth frame at the plurality of times and by the second output order according to the control signal, for driving the LCD device to display the fourth frame, wherein the polarity of the third frame is opposite to the polarity of the first frame; the polarity of the fourth frame is opposite to the polarity of the second frame; and a frame display sequence is the first frame, the third frame, the second frame and the fourth frame.

18. The LCD device of claim 15, wherein the control signal is a start-up signal for the first frame and the second frame.

19. The LCD device of claim 18, wherein the control signal is a vertical synchronization signal generated by the timing controller.

20. The LCD device of claim 15, wherein the control signal is carried by a polarization control signal generated by the timing controller.
